(19) United States
(12) Patent Application Publication
(10) Pub. No.: US 2024/0278463 A1
(43) Pub. Date: Aug. 22, 2024

(54) METHOD FOR MANUFACTURING A SENSOR FOR A MOTOR VEHICLE

(71) Applicant: Continental Automotive Technologies GmbH, Hannover (DE)

(72) Inventors: Hervé Contet, Toulouse (FR); Martin Throm, Toulouse (FR)

(21) Appl. No.: 18/444,991

(22) Filed: Feb. 19, 2024

(30) Foreign Application Priority Data
Feb. 21, 2023 (FR) 2301564

(51) Int. Cl. B29C 45/14; B29L 31/30; B29L 31/34

(52) U.S. Cl. CPC B29C 45/14065; B29C 45/14426; B29C 45/14467; B29C 2045/14131; B29L 2031/30; B29L 2031/3406

(57) ABSTRACT

A method for manufacturing a sensor for a motor vehicle, includes the steps of placement of the connection pins, positioning of a first mold, injection of material into the first mold so as to obtain a support overmolding comprising a receiving face and, on each lateral face, a holding member having a shape in relief of triangular section delimiting a cavity, placement of the sensitive element on the support overmolding, welding of the connectors, positioning of a second mold, which is different from the first mold, around the assembly formed by the pins and the support overmolding, and two holding pegs of which, for each peg, one end is housed in the cavity of one of the holding members, injection of material into the second mold so as to obtain the final overmolding of the sensor, removal of the mold so as to obtain the sensor.

### CROSS REFERENCE TO RELATED APPLICATIONS

This application claims priority to French Patent Application No. 2301564, filed Feb. 21, 2023, the contents of such application being incorporated by reference herein.

### FIELD OF THE INVENTION

The present invention relates to the field of sensors for motor vehicles and more particularly to a sensor and to a method for manufacturing such a sensor. The invention notably aims to improve the sealing and the alignment of the components of existing sensors.

### BACKGROUND OF THE INVENTION

In a known manner, a motor vehicle has measurement sensors that make it possible, for example, to measure the speed of rotation or the angular position of a drive shaft such as a crankshaft or a camshaft.

Still in a known manner, these sensors operate in association with a target fastened to the shaft of which it is desired to measure a parameter. The target is for example in the form of a toothed wheel of which the teeth vary an electromagnetic field generated by a magnet mounted in the sensor. The magnetic field variations are detected by sensitive elements, called measuring cells, of the sensor.

According to a known manufacturing method, the sensor is manufactured in a plurality of steps. First of all, an integrated circuit is overmolded with a polyepoxide material, commonly called “epoxy”, on a metal leadframe comprising connection pins, then the assembly is positioned in a mold and a magnet is optionally positioned on the integrated circuit. The assembly is overmolded allowing only the connection pins to project out. A final overmolding is applied in order to seal the sensor while at the same time forming an electrical connector of the sensor to the vehicle and a member for fastening the sensor, for example of the fastening ring type.

In certain cases, the sensor may be in contact with a liquid, for example by being immersed in an oil bath or in a mist of oil droplets. The sealing of the final overmolding is therefore important, in particular in order to prevent the liquid from penetrating inside the sensor along the electrical pins and damaging the measuring cells.

The correct alignment of the measuring cells of the sensor on the support overmolding and in the final overmolding is also necessary to ensure good performance of the sensor and avoid measurement errors.

It is then important to be able to ensure the orientation of the first overmolded assembly, called “support overmolding”, comprising the integrated circuit and the measuring cells, and optionally a magnet, during the subsequent overmolding operations.

One solution is to use a support overmolding comprising a foot to hold it straight. Another is to form cylindrical or rectangular protuberances on either side of the support overmolding, which are each configured to be fastened to an external peg or a cavity during the subsequent overmolding operations so as to hold the assembly supporting the measuring cells in a defined position. However, these two solutions do not make it possible to avoid defects in orientation that are due to the final overmolding. Another known solution is to use these two first solutions simultaneously on one and the same support overmolding in order to avoid these defects in orientation that are due to the final overmolding, but because of the resulting bulk, it limits the minimum size of the final sensor.

There is therefore a need for a solution that makes it possible to at least partially overcome these drawbacks.

### SUMMARY OF THE INVENTION

To this end, an aspect of the invention is first of all a method for manufacturing an electronic sensor for a motor vehicle, comprising a sensitive element and connection pins, said sensitive element comprising a casing and at least one integrated circuit, said casing of the sensitive element comprising cells for measuring a parameter, said at least one integrated circuit being electrically connected to said connection pins by connection tabs, said connection pins being on the one hand electrically connected to said connection tabs of the integrated circuit and on the other hand intended to be connected to an electrical network of the vehicle, said method for manufacturing a sensor comprising the steps of:
placement of the connection pins,
positioning of a first mold, for example around the connection pins and/or a magnet and/or an integrated circuit,
injection of material into the first mold so as to obtain a support overmolding, said support overmolding comprising a connection face from which the connection pins extend, a receiving face opposite the connection face and configured to receive the casing of the sensitive element, an upper face configured to receive at least one connector of the sensitive element, a lower face opposite the upper face and two opposite lateral faces each extending between the connection face, the receiving face, the upper face and the lower face, the support overmolding comprising, on each lateral face, a holding member extending from said lateral face and being configured to hold the support overmolding in a mold with a view to a final overmolding, each holding member having a shape in relief of triangular section delimiting a cavity at its center,
placement of the sensitive element on the support overmolding, the at least one integrated circuit (232) being placed so as to extend from the connection pins to the receiving face, passing via the upper face, and the casing of the sensitive element being placed on the receiving face,
welding of the connection tabs (232A) to the connection pins,
positioning of a second mold, which is different from the first mold, around the assembly formed by the connecting pins and the support overmolding, and two holding pegs of which, for each peg, one end is housed in the cavity of one of the holding members,
injection of material into the second mold so as to obtain the final overmolding of the sensor, said final overmolding comprising an electrical connection member surrounding the free ends of the connection pins, and a member for fastening the sensor to an element of the vehicle,
removal of the mold so as to obtain the sensor.

The triangular shape in relief of the holding members on the lateral faces of the support overmolding makes it possible to limit the defects in alignment of this piece. Unlike a cylindrical holding member, the triangular section imposes stricter geometrical constraints during the final overmolding step, which allows an upside-down inversion of the assembly formed by the pins and the support overmolding to be avoided and better alignment of this piece. The performance of the sensor is thus ensured. An aspect of the invention makes it possible to have holding members of relatively large size in proportion to the small size of the support overmolding, and this has the effect of making these holding members very robust because of the very low “exposure to the overmolding flow”. The short length and the simplicity of the reflow fins combined with a very small bulk of the support overmolding significantly reduces the risks of defects in sealing of the product after final overmolding. The use in the mold of the metal pegs that are inserted in the cavities delimited by the holding members has the effect of reinforcing these members at the moment of the injection of the final overmolding material, and is also useful for conveying this sub-component into the final molding tooling. Furthermore, the reflow fins are protected at the time of insertion of these metal pegs into the cavities by the protruding holding members. In this way, the pegs that are inserted into the cavities of the holding members are not in direct contact with the mold and the overmolding material during the final overmolding. They will thus be easier to remove at the end of this step.

Advantageously, the holding members are formed from the same material as the lateral faces of the support overmolding. This makes it possible to mold the support overmolding and the holding members in one go from the same material. The method is more efficient and the alignment of the holding members and the support overmolding is ensured.

Also preferably, the holding members of triangular section are arranged such that one face of said holding members is parallel to the upper face of the support overmolding. Thus, the upper face is wider and there is more room for the furrows receiving the electrical connection tabs connecting the casing of the sensitive element containing the measuring cells of the sensor to the connection pins.

Advantageously, the mold used during the final overmolding step comprises the definition of a groove of triangular shape around each holding member. The stability for the alignment of the support overmolding in the final overmolding is thus reinforced because of the geometrical constraints of the holding members of triangular section.

Also advantageously, the step of injection of material to produce the support overmolding comprises the creation of at least one reflow fin around each holding member, preferably two reflow fins, for example with a peripheral protection rib. These reflow fins make it possible to ensure the sealing between the support overmolding and the final overmolding enveloping the sensor. Specifically, the support overmolding is visible on the final sensor at the holding members and is therefore exposed to the liquid.

Advantageously, the method comprises a step of inscription of an identification marking on at least one of the holding members after the molding of this piece, preferably on its front face. This marking is useful for the logistical monitoring of sensors.

An aspect of the invention relates to the first mold for the shaping of the support overmolding, which mold is configured to, during an injection of material, define a support overmolding comprising a connection face from which the connection pins extend, a receiving face opposite the connection face and configured to receive the casing of the sensitive element, an upper face configured to receive at least one connector of the sensitive element, a lower face opposite the upper face and two opposite lateral faces each extending between the connection face, the receiving face, the upper face and the lower face, the support overmolding comprising, on each lateral face, a holding member extending from said lateral face and being configured to hold the support overmolding in a mold with a view to a final overmolding, each holding member having a shape in relief of triangular section delimiting a cavity at its center.

An aspect of the invention also relates to the second mold for the manufacturing of a sensor by the method as presented above for the overmolding of the final overmolding of the sensor, which mold is configured to leave accessible a part of the holding members of the support overmolding.

An aspect of the invention also relates to a sensor for a vehicle that is thus obtained with the method, comprising a connector for electrical connection to the vehicle and a member for fastening to an element of said vehicle.

An aspect of the invention also relates to a motor vehicle comprising a sensor as described above, fastened to an element of said vehicle and connected to a communication and electric power supply network of said vehicle.

### BRIEF DESCRIPTION OF THE DRAWINGS

Further features and advantages of aspects of the invention will become more clearly apparent upon reading the following description. This description is purely illustrative and should be read with reference to the appended drawings, in which:

FIG. 1 schematically illustrates a sensor after the manufacturing method according to an aspect of the invention.

FIG. 2 is a perspective view of the connection pins in the first step of the method according to an aspect of the invention.

FIG. 3 is a perspective view of the assembly formed by the connection pins and the support overmolding after the overmolding step of the method according to an aspect of the invention.

FIG. 4 is a view in cross section in the plane of the connection pins of the assembly formed by the connection pins and the support overmolding as shown in FIG. 3.

FIG. 5 is a perspective view of the assembly formed by the connection pins, the support overmolding and the integrated circuit connected to the measuring cells after the step of placement of the sensitive element of the method according to an aspect of the invention.

FIG. 6 schematically illustrates one embodiment of the method according to the invention.

### DETAILED DESCRIPTION OF THE PREFERRED EMBODIMENTS

The sensor obtained by the method according to an aspect of the invention is intended to be mounted in a motor vehicle. The sensor may be of any type. The sensor may, for example, be a position or speed sensor for a drive shaft such as a crankshaft or a camshaft or any other suitable shaft.

### Sensor 1

As shown in FIG. 1, the sensor 1 comprises an electrical connection connector 1A intended to be connected to an electrical network of the vehicle, a head 1B in which the measuring cells are situated and a fastening member 1C that makes it possible to fasten said sensor 1 in the vehicle.

The final overmolding 50 of the sensor 1 forms the outer envelope at the end of the manufacturing method according to an aspect of the invention.

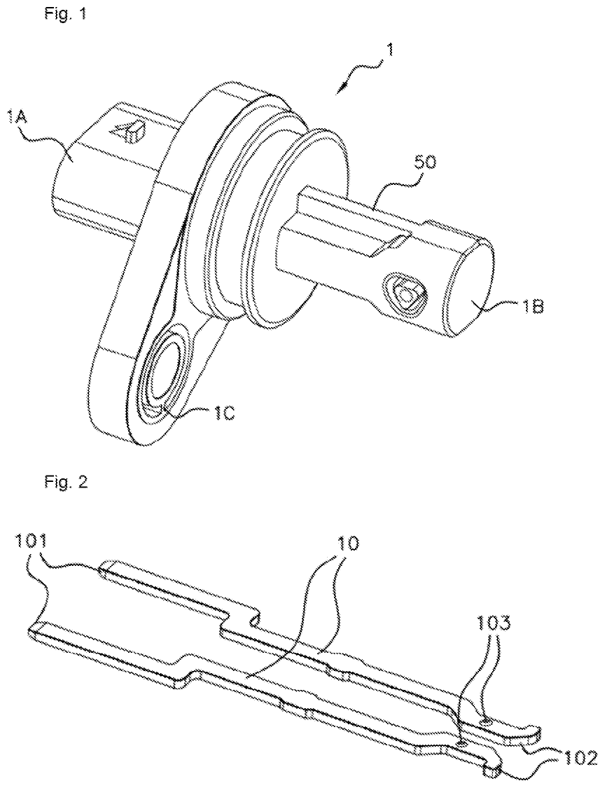

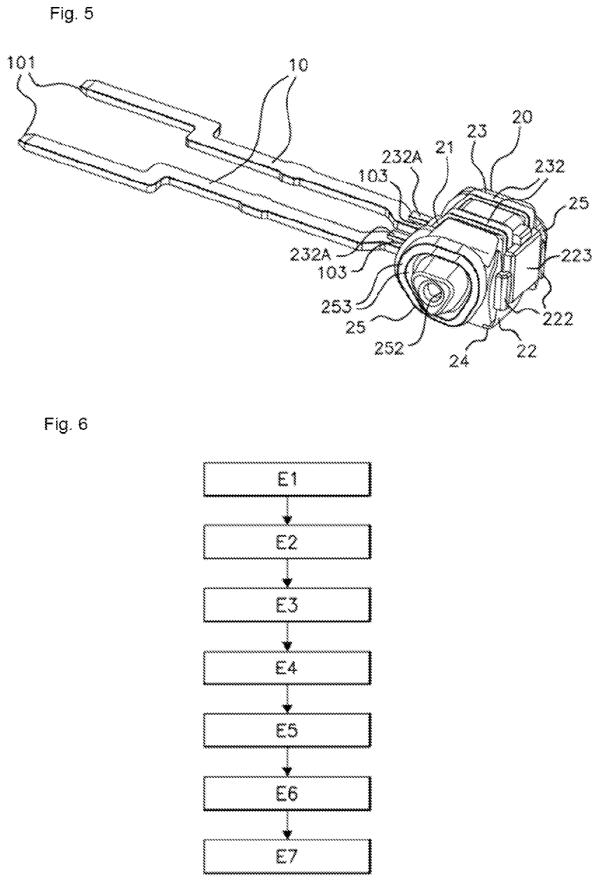

FIGS. 2 to 5 show an embodiment of the sensor 1 according to an aspect of the invention at various steps of the manufacturing method and FIG. 6 shows an embodiment of the method according to an aspect of the invention.

First of all, as illustrated in FIG. 2, the connection pins 10 are disposed on a support (which is not shown for the sake of clarity) in a step E1.

The connection pins 10, which are of rectangular section, each comprise a free end 101 intended to be electrically connected to an electrical network of the vehicle (not shown), and a connection end 102 overmolded in a support overmolding 20.

Each connection pin 10 has a pad 103 allowing said connection pin 10 to be electrically welded to a connection tab 232A of the integrated circuit 232 (visible in FIG. 5) of the sensor 1.

In a step E2, a mold in two parts is positioned on the connection ends 102 of the connection pins 10.

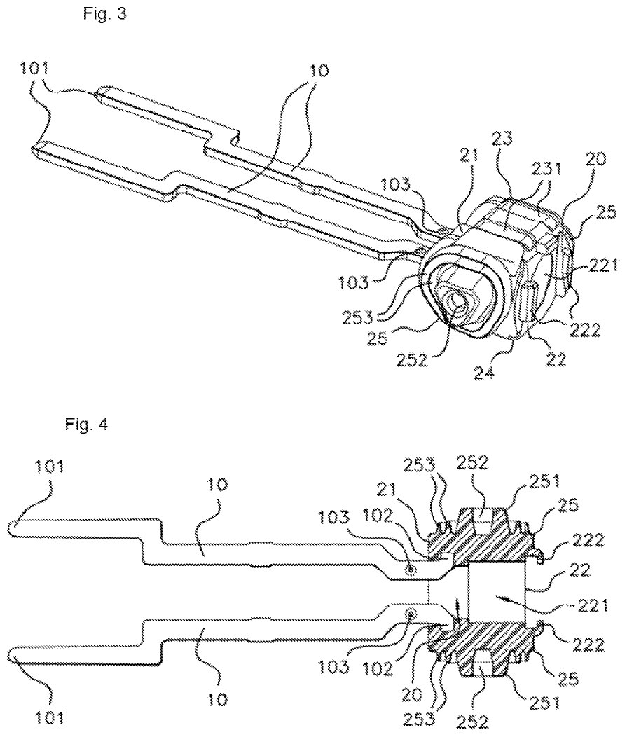

In a step E3, overmolding material is injected into the closed mold. The mold is configured to form a support overmolding 20 as shown in FIG. 3 after the removal of the two parts of the mold at the end of step E3.

Advantageously, during this step, identification inscriptions may be inscribed hollowed out or in relief on the surface of the holding members 251, such as for example an identifier of the mold or the place of production.

This support overmolding 20 comprises a connection face 21 from which the connection pins 10 extend, a receiving face 22, which is opposite the connection face 21, an upper face 23, a lower face 24 opposite the upper face 23 and two opposite lateral faces 25 each extending between the connection face 21, the receiving face 22, the upper face 23 and the lower face 24.

As shown in FIG. 4, the connection end 102 of the connection pins 10 is engaged in the material of the support overmolding 20 on the connection face 21.

The receiving face 22 comprises a cavity 221 for receiving a magnet and also supports 222 for fastening the casing of the sensitive element 223 shown in FIG. 5.

In another embodiment of the method, the magnet and/or the integrated circuit 232 of the casing of the sensitive element 223 could also be overmolded in the support overmolding 20, and an aspect of the invention could be used in a sensor 1 that does not have a magnet.

The upper face 23 comprises a plurality of furrows 231 for receiving the connection tabs 232A of the integrated circuit 232 shown in FIG. 5, which are welded to the connection pins 10 via the pads 103 and which are connected to the casing of the sensitive element 223.

Each lateral face 25 comprises a holding member 251 configured to hold the support overmolding 20 in a mold with a view to a final overmolding 50, each holding member 251 having a shape in relief of triangular section and delimiting a cavity 252 at its center.

Reflow fins 253 surround the holding members 251 on each lateral face 25.

In a step E4, the (optional) magnet and the casing of the sensitive element 223 are placed on the support overmolding 20, on the receiving face 22. The printed circuit 232 of the casing of the sensitive element 223 is placed in the furrows 231 and its connection tabs 232A are welded to the pads 103 of the connection pins 10.

For the second molding of step E5, the assembly formed by the connection pins 10 and the support overmolding 20 is held in place by holding pegs that are inserted in the cavities 252 of the holding members 251 of each lateral face 25.

The two parts of a second mold are positioned on the assembly so as to be fastened around the surfaces of the holding members 251 and leave a part of them outside.

The overmolding material is injected in step E6. The second mold is configured to create the final overmolding 50 of the sensor 1 as shown in FIG. 1.

In a step E7, the walls of the mold are removed, leaving the holding members 251 visible, and the method for manufacturing the sensor 1 according to an aspect of the invention is completed.

Advantageously, other identification inscriptions can be inscribed on the surface of the final overmolding 50 at the end of the method, for example by laser marking.

An aspect of the invention thus proposes a reliable and efficient method for reducing or even eliminating defects in alignment during manufacturing of the sensor.

1. A method for manufacturing an electronic sensor for a vehicle, said sensor comprising a sensitive element and connection pins, said sensitive element comprising a casing and at least one integrated circuit, said casing of the sensitive element comprising cells for measuring a parameter, said at least one integrated circuit being electrically connected to said connection pins by connection tabs, said connection pins being on the one hand electrically connected to said connection tabs of the integrated circuit and on the other hand intended to be connected to an electrical network of the vehicle, said method comprising:
placement of the connection pins,
positioning of a first mold,
injection of material into the first mold so as to obtain a support overmolding, said support overmolding comprising a connection face from which the connection pins extend, a receiving face opposite the connection face and configured to receive the casing of the sensitive element, an upper face configured to receive at least one integrated circuit of the sensitive element, a lower face opposite the upper face and two opposite lateral faces each extending between the connection face, the receiving face, the upper face and the lower face, the support overmolding comprising, on each lateral face, a holding member extending from said lateral face and being configured to hold the support overmolding in a mold with a view to a final overmolding, each holding member having a shape in relief of triangular section delimiting a cavity at its center,
placement of the sensitive element on the support overmolding, the at least one integrated circuit being placed so as to extend from the connection pins to the receiving face, passing via the upper face, and the casing of the sensitive element being placed on the receiving face and welding of the connection tabs to the connection pins,
positioning of a second mold, which is different from the first mold, around the assembly formed by the pins and the support overmolding, and two holding pegs of which, for each peg, one end is housed in the cavity of one of the holding members,
injection of material into the second mold so as to obtain the final overmolding of the sensor, said final overmolding comprising an electrical connection connector surrounding the free ends of the connection pins, and a member for fastening the sensor to an element of the vehicle, and
removal of the mold so as to obtain the sensor.

2. The method as claimed in claim 1, wherein during the step of injection of the final overmolding, the injected material surrounds the holding members so as to leave them at least partially visible on the sensor.

3. The method as claimed in claim 1, wherein the holding members are formed from the same material as the lateral face of the support overmolding.

4. The method as claimed in claim 1, wherein the holding members of triangular section are arranged such that one face of said holding members is parallel to the upper face of the support overmolding.

5. The method as claimed in claim 1, wherein the final overmolding step comprises the definition of a groove of triangular shape around each holding member.

6. The method as claimed in claim 1, wherein the step of injection of material to produce the support overmolding comprises the creation of at least one reflow fin around each holding member with a peripheral protection rib.

7. The method as claimed in claim 1, further comprising affixing of an identification marking to at least one of the holding members.

8. A sensor obtained by the method as claimed in claim 1, said sensor comprising a connector for electrical connection to the vehicle and a member for fastening said sensor to an element of the vehicle.

9. A motor vehicle comprising a sensor as claimed in claim 8, fastened to an element of said vehicle and connected to a communication and electric power supply network of said vehicle.

10. The method as claimed in claim 1, wherein the step of injection of material to produce the support overmolding comprises the creation of two reflow fins with a peripheral protection rib around each holding member.

11. The method as claimed in claim 1, further comprising affixing of an identification marking to at least one of the holding members to its front face.
